(19) United States
(12) Patent Application Publication
(10) Pub. No.: US 2008/0251968 A1
(43) Pub. Date: Oct. 16, 2008

(54) RFID HARD CASE DEVICE AND METHOD OF MANUFACTURE

(75) Inventors: John E. Misner, Grandville, MI (US); Brian G. Parker, Alto, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: CASCADE ENGINEERING, INC., Grand Rapids, MI (US)

(21) Appl. No.: 11/733,217

(22) Filed: Apr. 10, 2007

(51) Int. Cl. B29C 45/14

(52) U.S. Cl. 264/272.15; 340/568.1

(57) ABSTRACT

An RFID enabled waste/recycling container includes a molded plastic body; and a case containing an RFID device. The case includes a front surface and a rear surface defining a wedge-shape. The case is in-molded with the plastic body such that a substantial portion of the front surface and the rear surface are exposed. In another embodiment, the case is also designed to snap-fit to a waste/recycling container.

### BACKGROUND OF THE INVENTION

The present invention relates to waste and recycling containers, and more particularly to waste and recycling containers including radio frequency identification (RFID) devices.

With increasing frequency, waste and recycling containers are being equipped with radio frequency identification (RFID) devices. An RFID device enables the container to be uniquely identified or associated with a customer or pick-up address. The RFID device typically is read during emptying of the container by an RFID reader within the equipment for lifting and/or weighing the container. Where charges are based on the weight of the waste (or where rebates, rewards, or other benefits are provided based on the weight of the recyclable materials), the RFID device enables weight information to be accurately associated with a customer or a pick-up address to enable accurate and reliable customer billing.

One way of equipping a plastic waste container with an RFID device is to mold the device into the body (e.g. the sidewall) of the container. One example of this approach, described in U.S. Pat. No. 6,302,461, includes encapsulating an RFID device in a protective shell, and molding the protective shell into the sidewall of a plastic waste container. Unfortunately, attempts at implementing this approach have been unsuccessful and at best inconsistent because of the temperatures and pressures associated with injection molding. Even when the device is encapsulated in a protective shell, the heat and pressure of plastic flowing over the shell can render the device inoperable. The container therefore becomes unusable. As a result, manufacturers continue to search for an apparatus and method for securely and consistently attaching an RFID device to a plastic waste container.

### SUMMARY OF THE INVENTION

The aforementioned problems are overcome by the present invention wherein an RFID device is protectively enclosed in a case that is designed to be incorporated into a waste/recycling container in structure and processes that reduce potential harm to the RFID device.

In one embodiment, the case is relatively flat and includes relatively large front and rear surfaces. The surfaces define a wedge shape for the case in cross section. The RFID device is protectively enclosed within the case to withstand in-molding as described below. In a second embodiment, the waste container includes the in-molded case. At least a portion of both the front surface and the rear surface are not covered by plastic, so that the case is protected from the pressures and temperatures of the injection molding process.

In another embodiment, the present invention is directed to a method for manufacturing a waste/recycling container with an RFID device, including the steps of: a) placing an RFID device in a case, the case having a front surface and a rear surface that combine to form a wedge shape; b) providing a mold having a mold surface and a pocket defined in the mold surface, the pocket having at least two walls that converge to form a wedge shape corresponding to the wedge shape of the case; c) placing the case in said pocket, such that a substantial portion of the front and rear surfaces of the case engage the converging walls of the pocket and other portions of the case are exposed; d) injecting a thermoplastic onto the mold surface and over the pocket, the thermoplastic contacting only the exposed portions of the case; e) curing the thermoplastic so the case is securely attached to the cured thermoplastic; and f) removing the molded article from the mold.

In another embodiment, the case is also designed to snap-fit to a portion of a waste/recycling container. The case may include first and second longitudinal ends, a first attachment mechanism on the first end, and a second attachment mechanism on the second end. The first mechanism is adapted to interfit with a first attachment portion on a container, and the second mechanism is adapted to interfit with a second attachment portion on a second rib on the container. The case may snap-fit to a container that already has an in-molded case, for instance, when the in-molded case has failed, or the case may snap-fit to a container that does not include a case.

The present invention enables attachment of an RFID device to a waste/recycling container without destroying the functionality of the device during the attachment process. The wedge shape of the case and corresponding wedge shape of the mold pocket enables a secure fit within the mold that prevents the flow of plastic over the front and rear surfaces of the case—protecting the RFID device from the heat and pressure of the molten thermoplastic. The protrusions on the case further enable retrofitting of the case to containers with or without an in-molded case.

These and other objects, advantages, and features of the invention will be fully understood and appreciated by reference to the description of the current embodiment and the drawings.

### BRIEF DESCRIPTION OF THE DRAWINGS

FIG. 1 is a perspective view of an RFID hard case according to one embodiment of the present invention.

FIG. 2 is an exploded view thereof.

FIG. 3 is a bottom perspective view of an RFID hard case molded into a portion of a container.

FIG. 4 is a cross sectional view taken along line 4-4 in FIG. 3.

FIG. 5 is a bottom perspective view of an RFID hard case attached to a container according to an alternative embodiment.

FIG. 6 is a perspective view of a mold according to one embodiment of the present invention.

FIG. 7 is a cross sectional view of the mold.

### DESCRIPTION OF THE CURRENT EMBODIMENT

I. Overview

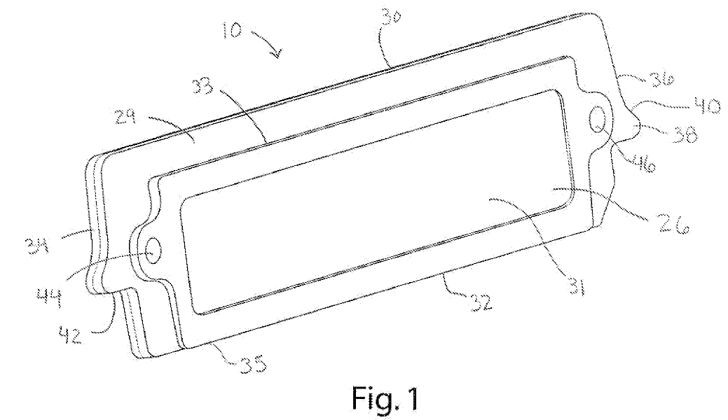

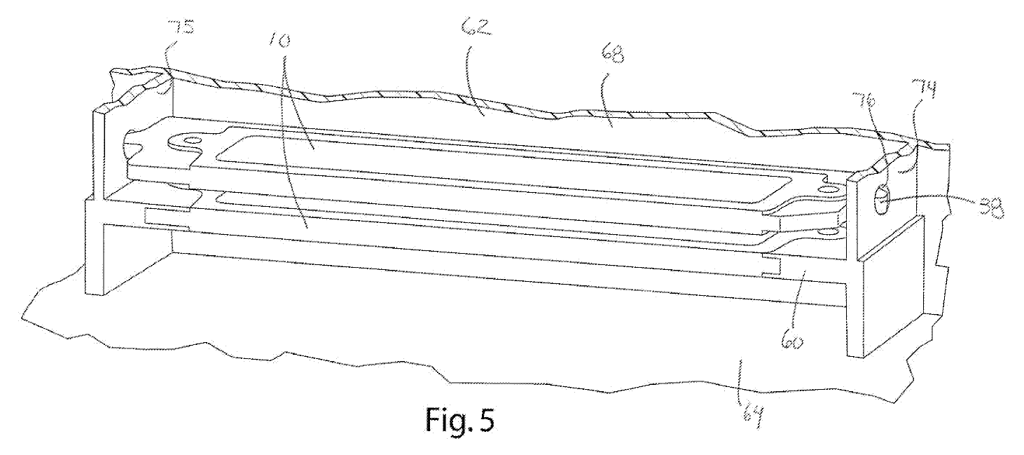

An RFID hard case according to one embodiment of the present invention is shown in FIG. 1 and generally designated 10. In one embodiment, shown in FIG. 5, the RFID hard case 10 is designed to be molded into a plastic item, such as a waste/recycling container 12. In one embodiment, the RFID hard case 10 is also designed to snap-fit into a portion of the waste/recycling container 12. For purposes of illustration, the invention will be described in connection with a waste/recycling container. It should be appreciated, however, that the construction and method described herein could be applied to attach an RFID device to a wide variety of plastic items.

II. Structure

The case 10 is typically injection molded plastic, but may be formed from a variety of materials. In one embodiment, the case 10 includes a first half 14 and a second half 16. The halves 14 and 16 are generally identical and include interior surfaces 18, 20 respectively that each define a cavity 22. In one embodiment, the interior surfaces 18, 20 can be connected together by a conventional method, such as sonic welding or an adhesive, to enclose an RFID device 24.

The assembled case 10 includes a front surface 26, a rear surface 28 opposite the front surface 26, an upper edge 30, a lower edge 32, and first and second longitudinal edges 34, 36. The front 26 and rear 28 surfaces may each include a peripheral portion 29, and a central portion 31. In one embodiment, the peripheral portion 29 extends along the first and second longitudinal edges 34, 36 and the upper edge 30. In one embodiment, the central portion 31 is a portion of the front 26 and rear 28 surfaces that protrudes outwardly from the peripheral portion 29. In the illustrated embodiment, an upper side 33 of the central portion 31 protrudes outwardly a greater distance than a lower side 35, such that the case 10 has a wedge shaped cross-section.

In one embodiment, each longitudinal edge 34, 36 includes a protrusion 38 extending outwardly therefrom. The protrusion 38 may include an upper surface 40 and a lower surface 42, and in one embodiment the upper surface 40 has a rounded shape. As described below, the rounded shape of the upper surface 40 enables the case 10 to be snap-fitted to a portion of the container 12. As shown in FIG. 1, the case 10 may additionally include a pair of holes 44, 46 that extend through the front 26 and rear 28 surfaces of the case 10. In the illustrated embodiment, the holes 44, 46 are located in the central portion 31 proximate the longitudinal edges 34, 36 respectively.

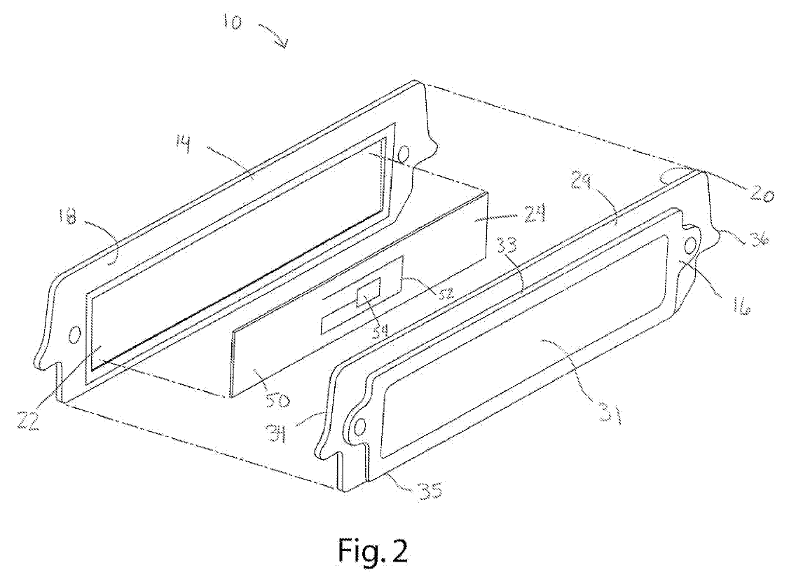

In one embodiment, the RFID device 24 is a conventional RFID label. The RFID label is disposed between the cavities 22 of the two case halves 14, 16. In the illustrated embodiment, shown in FIG. 2, the RFID label 24 includes a substrate 50, an antenna 52 attached to the substrate 50, and a transceiver or chip 54 attached to the substrate 50 and in electrical connection with the antenna.

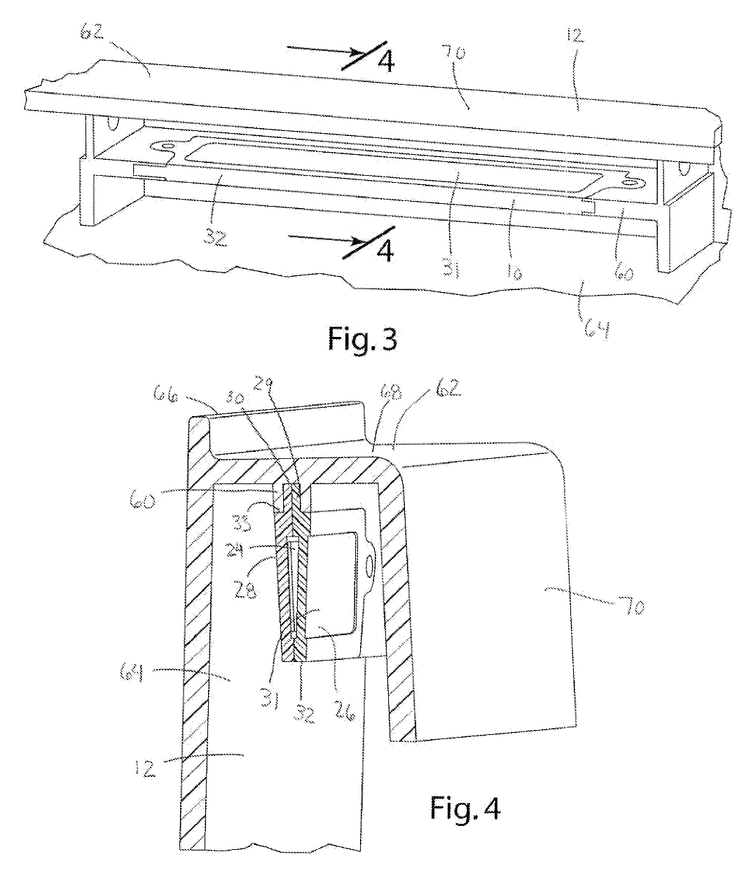

Referring now to FIGS. 3 and 4, in one embodiment, the case 10 is in-molded into a portion of the waste/recycling container 12. In the illustrated embodiment, the case 10 is in-molded into a rib 60 extending from the rim 62 of the container 12. As shown, the container 12 includes a sidewall 64 having an upper edge 66 of the container 12. The rim 62 includes a first member 68 that extends outwardly from the sidewall 64 proximate the upper edge 66 of the container 12. In one embodiment, the first member 68 extends approximately perpendicular to the sidewall 64. The rim 62 further includes a second member 70 that extends downwardly from the first member 68. As illustrated, the rib 60 extends downwardly from the first member 68 between the sidewall 64 and the second member 70. The case 10 is molded into the rib 60 such that a substantial portion of the front 26 and rear 28 surfaces of the case 10 is exposed. In the illustrated embodiment, the entire central portion 31 of the front 26 and rear 28 surfaces is exposed. The peripheral portion 29, along with the upper edge 30 and longitudinal edges 34 and 36, are surrounded by plastic to secure the case 10 in the rib 60.

In one embodiment, shown in FIG. 5, the case 10 may alternatively be snap-fitted to a portion of the container 12. As shown in FIG. 5, a case 10 may be snap-fitted to a container 12 directly in front of a case 10 that has previously been molded into the container 12, for instance, if the RFID device in the in-molded case 10 has failed after a period of time. In one embodiment, the container 12 includes a pair of support ribs 74, 75 located in the rim 62 and extending perpendicular to the rib 60 in which the case 10 is in-molded. The support ribs 74, 75 each include a hole 76 into which the protrusions 38 on the longitudinal edges 34, 36 may be snap-fitted. Alternatively, the snap-fit portion of the container 12 may be located in a different location on the container that is separate from the in-molded case 10, or on a container that does not include an in-molded case 10. In another embodiment, not shown, the holes 44, 46 in the case 10 may be used to attach the case 10 to a container 12 with conventional fasteners extending through the holes and into the container.

III. Mold

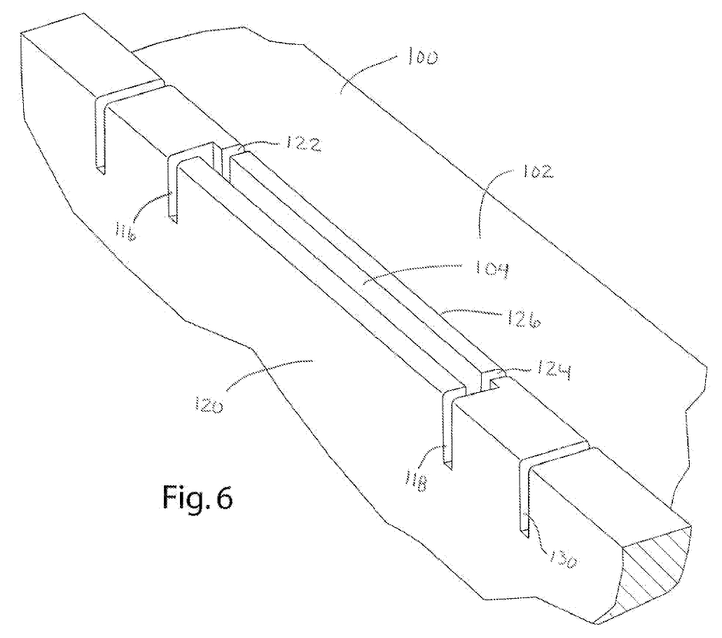

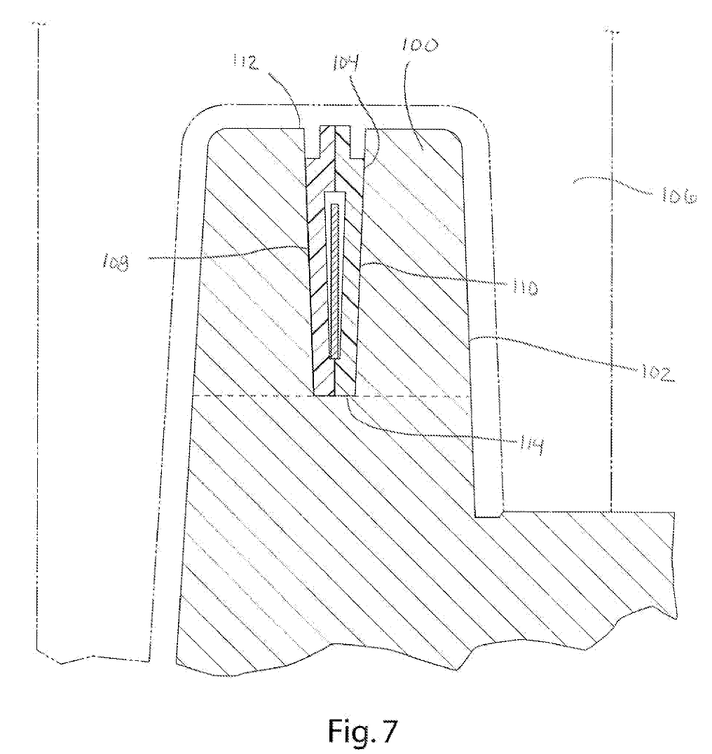

FIGS. 6 and 7 show an embodiment of the mold 100 for use in in-molding the case 10 into the rim 62 of the container 12. In one embodiment, the mold 100 includes mold surface 102 that is shaped to correspond to the desired shape of the container 12, and a pocket 104 defined in the surface 102 into which the case 10 may be inserted. An upper mold member 106 (shown in phantom lines in FIG. 7) may be lowered to mate with the mold surface 102 to form the container 12 including the case 10. In one embodiment, the pocket 104 is sized to correspond to the shape of the case 10, such that the pocket 104 tightly receives the case 10. As shown in FIG. 7, the pocket 104 includes a pair of walls 108, 110 that converge from the opening 112 toward the bottom 114 of the pocket 104 to form a wedge shape that matches the wedge shape of the case 10. This arrangement allows a case 10 to be inserted into the pocket 104 with the front and rear surfaces 26 and 28 of the case in tight contact with the walls 108 and 110 to prevent plastic from flowing over those portions of the front 26 and rear 28 surfaces of the case 10 that contact the walls 108, 110. The pocket 104 may include a pair of notches 116, 118 defined in a front surface 120 and a second pair of notches 122, 124 defined in a rear surface 126 that expose portions of the case 10 to allow injected plastic to flow over those portions of the case 10. In the illustrated embodiment, the notches 116, 118, 122 and 124 expose the peripheral portion 29. The notches 116, 118 also provide for the formation of support ribs 74, 75. In one embodiment, the mold surface 102 includes additional notches 130 for forming additional support ribs (not shown) in the area of the rim 62.

In an alternative embodiment, the mold may be configured so that one of the mold halves includes a portion that contacts the front surface 26 of the case 10, and the other mold half includes a portion that contacts the rear surface 28 of the case 10. In this embodiment, the mold halves form a “pocket” that contacts the front 26 and rear 28 surfaces of the case 10 when the mold is closed. In another embodiment, the mold may include one or more slides that can be moved into position to contact the front 26 and/or rear 28 surfaces of the case 10, or other desired portions of the case 10 to prevent plastic from flowing over those portions of the case 10.

IV. Method of Manufacture

In one embodiment, the case 10 is manufactured by injection molding. Each of the halves 14, 16 of the case may be injection molded separately, and then the interior surfaces 18, 20 of the halves may be attached together by a conventional method, such as sonic welding or an adhesive, with the RFID device 24 disposed between them. In one embodiment, the RFID label is sized so that it fits loosely within the case 10. The 10 case may be attached to the waste/recycling container 12 by in-molding, snap-fitting or with fasteners.

In one embodiment, the case 10 is in-molded into the waste/recycling container 12 by placing the case 10 in the pocket 104 in the mold 100, such that the front 26 and rear 28 surfaces of the case 10 engage and contact the walls 108, 110 of the pocket 104. After the case 10 is placed in the pocket 104, a molten thermoplastic is injected over the mold surface 102, such that it flows over the pocket 104 and the exposed portions of the case 10, including the peripheral portion 29. Due to the engagement of the case 10 with the pocket 104, the central portion 31 of the front 26 and rear 28 surfaces of the case 10 does not contact the molten thermoplastic. The upper mold portion 106 may be lowered or otherwise moved into place above the mold surface 102 to form the thermoplastic into the desired shape of the container 12. After the thermoplastic has been formed and cooled (or in some cases during the cooling process), the container 12, including the in-molded case 10, can be removed from the mold 100.

In another embodiment, the case 10 is snap-fitted to the container 12 by snapping each of the protrusions 38 into the holes 76 in the support ribs 74. In yet another embodiment, the case 10 may be attached to a surface of the container 12 with fasteners, such as rivets, that extend through the holes 44, 46 in the case 10 and into the container 12. As described above, a case 10 may be snap-fitted or fastened to a container 12 that includes an in-molded case 10, or to a container that previously did not include a case 10.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. An RFID enabled waste/recycling container comprising:
a molded plastic container body; and
a case containing an RFID device, said case having a front surface and a rear surface defining a wedge-shape, said case molded to said plastic container body such that at least a substantial portion of both of said front surface and said rear surface are exposed.

2. The waste/recycling container of claim 1 wherein the container includes a rim, and wherein said plastic portion is a rib extending from said rim.

3. The waste/recycling container of claim 1 wherein said case includes first and second longitudinal ends, and first and second protrusions extending from said first and second longitudinal ends respectively.

4. The waste/recycling container of claim 4 including a second said case, and first and second ribs extending from the container, each said rib defining a hole, said first and second protrusions on said second case snap-fitted into said holes of said first and second ribs respectively.

5. The waste/recycling container of claim 1 wherein said RFID device is an RFID label, said label including a substrate, an antenna attached to said substrate, and an RFID chip in electrical connection with said antenna.

6. The waste/recycling container of claim 1 wherein said case includes a peripheral portion and a central portion, said central portion forming a majority of said front and rear surfaces of said case, said first and second longitudinal ends and a portion of said front and rear surfaces, said plastic portion molded to said peripheral portion, said plastic portion not molded to said central portion.

7. The waste/recycling container of claim 6 wherein said central portion of each of said front and rear surface protrudes outwardly from said front and rear surfaces.

8. The waste/recycling container of claim 7 wherein said central portion protrudes outwardly from said front and rear surfaces to define said wedge shape.

9. An RFID enabled waste/recycling container comprising:
a container body including first and second attachment portions;
a case including an interior and an exterior, said interior defining a cavity, said exterior having first and second attachment portions extending from said case, said first case attachment portion interfitted with said first container attachment portion, and said second case attachment portion interfitted with said second container attachment portion; and
an RFID device within said cavity within said case.

10. The RFID enabled waste/recycling container of claim 9 wherein said case includes first and second longitudinal ends, said first protrusion extending from said first longitudinal end, said second protrusion extending from said second longitudinal end.

11. The RFID enabled waste/recycling container of claim 10 wherein said case includes a front surface and a rear surface that combine to form a wedge shape.

12. The waste/recycling container of claim 10 wherein said case defines a first hole and a second hole, said holes each located proximate one of said longitudinal ends and extending through said front and rear surfaces.

13. The waste/recycling container of claim 9 wherein said container includes a sidewall, and a rim extending outwardly from said sidewall, said case first and second ribs extending from said rim.

14. The waste/recycling container of claim 9 wherein said first and second protrusions each include a curved surface.

15. The waste/recycling container of claim 9 including a second said case molded to said container.

16. A method of manufacturing a waste/recycling container with an RFID device, comprising:
placing an RFID device in a case, said case having a front surface and a rear surface that combine to form a wedge shape;
providing a mold having a mold surface, and a pocket defined in said mold surface, said pocket having two walls that converge to form a wedge shape corresponding to said wedge shape of said case;
placing said case in said pocket, such that a substantial portion of said front and rear surfaces of said case engage said converging walls of said pocket and other portions of said case are exposed;
injecting a thermoplastic onto said mold surface and over said pocket, said thermoplastic contacting only said exposed portions of said case;
curing said thermoplastic; and
removing said container including said case from said mold.

17. A method of molding a container comprising:
placing an RFID device within a case;
placing the case in a mold with a substantial majority of the case surface in substantial direct contact with the mold wall;
injection molding plastic into the mold;
allowing the plastic to solidify; and
removing the container from the mold.

18. An RFID assembly comprising:
a case having an interior defining a cavity, and an exterior including a front surface and a rear surface, said first and second surfaces converging such that said portions of said front and rear surfaces form a wedge shape; and
and RFID device disposed within said cavity within said case.

19. The RFID assembly of claim 18 wherein said front and rear surfaces each include a peripheral portion and a central portion, said central portion of said front surface defining said first plane, said central portion of said rear surface defining said second plane.

20. The RFID assembly of claim 18 including first and second longitudinal ends, each said end including a protrusion for snap-fitting said case to an item.

21. The RFID assembly of claim 20 including at least one fastener hole extending through said case for extending a fastener through said hole to attach said case to an item.

22. An RFID assembly comprising:
a case having an interior defining an opening, and an exterior including a first end, a second end, a first protrusion extending from said first end and a second protrusion extending from said second end; and
an RFID device within said opening of said case.

23. The RFID assembly of claim 22 wherein at least a portion of said case has a wedge shape.
